(19) United States
(12) Patent Application Publication
(10) Pub. No.: US 2010/0039536 A1
(43) Pub. Date: Feb. 18, 2010

(54) Video recording device and method

(75) Inventors: Lars Dahllof, Stockholm (SE); Trevor Lyall, Lidingoe (SE)

Correspondence Address: EDWARDS ANGELL PALMER & DODGE LLP, P.O. BOX 55874, BOSTON, MA, 02205, US

(73) Assignee: Sony Ericsson Mobile Communications AB, Lund (SE)

(21) Appl. No.: 12/228,577

(22) Filed: Aug. 14, 2008

(51) Int. Cl. H04N 5/262; H04N 7/12

(52) U.S. Cl. 348/240.99; 375/240.01; 348/E05.051; 375/E07.076

(57) ABSTRACT

Video recording devices and corresponding methods are disclosed. In an embodiment, when a zoom arrangement is operated to change a field of view, an encoder for encoding images captured by a sensor and for outputting a corresponding stream of video frames changes the rate of frames which are encoded only upon themselves per time unit.

### FIELD OF THE INVENTION

The present invention relates to video recording devices and methods.

### BACKGROUND

Electronic devices used for video recording, i.e. video recording devices, have become increasingly popular with the possibility of recording videos digitally, for example using CCD (charge coupled device) or CMOS (complementary metal oxide semiconductor) image sensors. Such video recording devices do not only include dedicated video recorders, but also other devices which offer the possibility of recording videos. For example, many digital cameras nowadays, besides being able to take still pictures, also offer the possibility to record at least short video clips. Also for example mobile phones or even laptop computers often have built-in digital cameras which offer the possibility to record videos. A video, in this respect, is to be understood as a series of images taken one after the other which are intended to be played back consecutively, so as to for example create an impression of movement. In the context of video recording, the individual images are also referred to as frames.

In order to create a smooth impression of movement, a plurality of frames per second have to be recorded and played back later, for example with a frame rate of 24 frames per second, although both higher frame rates like 32 frames per second and lower frame rates like 16 frames per second or 8 frames per second are also used. Even with moderate resolutions of about one to two million picture elements (pixels) per frame, this leads to large amount of data being recorded.

In order to be able to store such video on a data carrier like a memory card, efficient compression schemes have been developed. Many of such compression schemes rely on the fact that the changes from one frame to the next are usually comparatively small. Therefore, frames are encoded based on previous frames, i.e. essentially only the differences to one or more previous frames are encoded instead of encoding the full frame. Other frames may be encoded using both information from previous frames and information from following frames. In such an encoding scheme, in regular intervals a frame which is not encoded based on previous frames, but which may be encoded by some compression scheme based on itself (for example JPEG-like compression) is inserted in the stream of frames to be used as a reference for later frames. Such frames which do not rely on previous frames are sometimes referred to as I-frames (intra-coded frame).

Obviously, such an encoding based on previous or following frames works best if there is little change from frame to frame. Rapid changes may for example occur when the video recording device comprises a zoom, in particular an optical zoom, i.e. an element which is able to change its focal length and therefore the angle defining the field of view recorded. Such “zooming” may be performed rapidly, which changes the recorded frames correspondingly.

### SUMMARY OF THE INVENTION

According to an embodiment, a video recording device is provided, comprising an image sensor, a zoom arrangement operable to change an angle defining a field of view seen by said sensor, and an encoder. The encoder is configured to output a stream of video frames based on an output of said sensor, wherein said video frames comprise first frames, wherein each first frame is encoded based only upon itself, and second frames, wherein each second frame is encoded based on at least one frame preceding the respective second frame. Said encoder is further configured to increase a rate of said first frames per time unit during at least part of a time period in which said zoom arrangement is operated to change said angle defining the field of view.

Said rate of said first frames per time unit may for example be increased during the complete time period in which the zoom arrangement is operated to change said angle defining the field of view.

In an embodiment, said zoom arrangement may comprise a plurality of optical elements, wherein at least one of said optical elements is movable to change said angle defining the field of view.

Said encoder may for example be configured to generate said stream of video frames based on an MPEG-standard.

Said video recording device may for example be a mobile phone, a laptop computer, a digital camera, a video camera or a portable music player.

Said image sensor may comprise a CCD sensor or a CMOS sensor.

Each of said first frames may be an I-frame, and each of said second frames may for example be a P-frame or a B-frame.

The video recording device in an embodiment may further comprise a control unit, wherein said control unit is configured to receive a user input indicative of a desire of a user to change said angle defining the field of view and to output a first control signal controlling said zoom arrangement to change said angle defining the field of view and a second control signal controlling said encoder to increase said rate of said first frames per time unit.

According to another embodiment a method is provided, comprising:
capturing a series of images,
encoding said stream of images into a stream of video frames, wherein said video frames comprise first frames, wherein each first frame is encoded only based upon itself, and second frames, wherein each second frame is encoded based on at least one frame preceding the respective second frame,
changing an angle defining a field of view seen by said image sensor, and
increasing a rate of said first frames per time unit in said stream of video frames during at least part of the time the angle defining the field of view is changed.

Said changing of said angle defining said field of view may comprise operating an optical zoom arrangement.

Said encoding may for example be performed based on an MPEG-standard.

Each of said first frames may be an I-frame, and each of said second frames may be either a P-frame or a B-frame.

The features of the above embodiments may be combined with each other unless noted to the contrary.

### BRIEF DESCRIPTION OF THE DRAWINGS

FIG. 1 shows a simplified block diagram of a device according to an embodiment.

FIG. 2 shows an exemplary diagram illustrating the encoding of frames according to an embodiment of the present invention.

### DETAILED DESCRIPTION OF THE INVENTION

In the following, embodiments of the present invention will be described in detail with reference to the accompanying drawings. It is to be understood that the following description of embodiments is given only for the purpose of illustration and is not to be taken in a limiting sense. The scope of the invention is not intended to be limited neither by the embodiments described hereinafter nor by the drawings, which are taken to be illustrative only, but is intended to be limited only by the appended claims and equivalents thereof.

It should be noted that the drawings are to be regarded as being schematic representations only, and elements in the drawings are not necessarily to scale with each other. Rather, the representation of the various elements is chosen such that their function and general purpose become apparent to a person skilled in the art.

It is also to be understood that the following description of embodiments, any direct connection or coupling between functional blocks, devices, components, circuit elements or other physical or functional units shown in the drawings or described herein, i.e. any connection or coupling without intervening elements, could also be implemented by an indirect connection or coupling, i.e. a connection or coupling with one or more additional intervening elements. Furthermore, it should be appreciated that the partitioning of embodiments in functional blocks or units shown in the drawings is not to be construed as indicating that these units necessarily are implemented as physically separate units, but functional blocks or units shown or described may be implemented as separate units, circuits, chips or circuit elements, but one or more functional blocks or units may as well be implemented in a common circuit, chip, circuit element or unit.

It is to be understood that the features of the various embodiments described hereinafter may be combined with each other unless specifically noted otherwise.

Furthermore, it is to be understood that describing an embodiment comprising a plurality of elements or features is not to be construed as indicating that all these elements or features are necessary for practicing the present invention. Instead, in other embodiments, only some of such elements or features may be implemented, and/or alternative or additional elements or features may be provided.

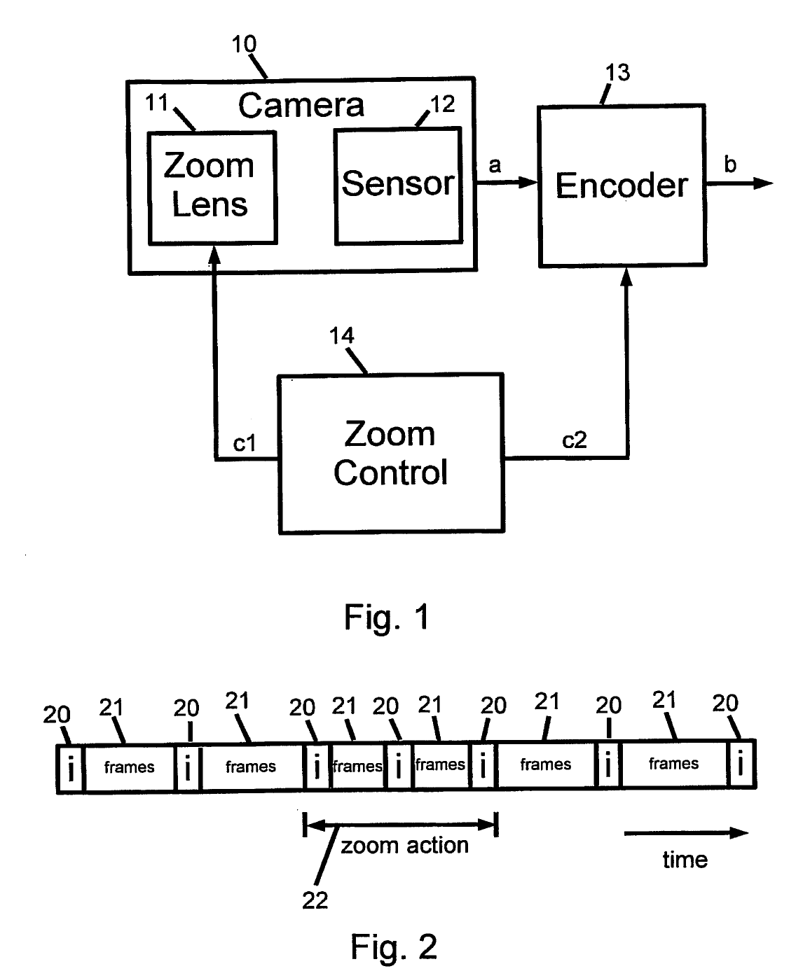

Turning now to FIG. 1, a video recording device according to an embodiment of the present invention is shown. The video recording device of the embodiment of FIG. 1 may be a dedicated video recording device, for example a so-called camcorder, but may also be any other kind of portable electronic device with video recording capabilities, for example a correspondingly equipped mobile phone, digital camera, laptop computer or portable music player. It should be noted that in FIG. 1 only some components of the video recording device are shown, and the video recording device may or may not comprise further components depending on the type of video recording device. For example, in case the video recording device is a mobile phone, components conventionally found in mobile phones like an antenna, a microphone, a SIM card or interface therefore or other electronic components may be present although not explicitly shown in FIG. 1.

The video recording device according to the embodiment of FIG. 1 comprises a camera 10 for capturing images and outputting corresponding image data a. Camera 10 comprises a zoom lens or zoom lens arrangement 11 and a sensor 12. In this respect, it should be noted that the term “lens” is generally used in the art both to designate single lens elements for example concave lenses or convex lenses and arrangements which comprise a plurality of such individual lens elements. Moreover, lenses in the latter sense may comprise additional elements like diffractive elements. In general, in the context of the present invention, a zoom lens is to be understood an arrangement of one or more optical elements like individual lens elements or diffractive elements which may be controlled to change a focal length of the zoom lens. Such a changing of focal length may for example be achieved by moving one or more optical elements within the zoom lens and leads to a change of an angle α defining the field of view of the zoom lens and therefore also of the corresponding field of view seen by the sensor. In particular, the larger the focal length is, the smaller the angle α defining the field of view becomes.

Zoom lens 11 of camera 10 is adapted to guide light captured by zoom lens 11 to a sensor 12 which then transforms the light received into image data a. By changing the focal length of zoom lens 11, which is also referred to as “zooming”, as mentioned above the angle α defining the field of view of camera 10 may be changed. Sensor 12 for example may be a CCD (charge coupled device) or a CMOS (complementary metal oxide semiconductor) sensor.

In order to capture a video, a desired number of images per time unit corresponding to a desired frame rate, for example 16 frames per second (fps), 24 frames per second or 30 frames per second is read out from sensor 12, wherein it should be noted that the aforementioned examples for frames rates are not to be construed as limitative, and any desired frame rate within the limits given by the capabilities of the sensor and circuit used may be employed.

The thus read-out image data a is encoded by an encoder 13 in order to generate a compressed video stream b. The encoding may use any conventional encoding scheme like one of the encoding schemes promoted by the motion picture expert group (MPEG), for example MPEG-1 or MPEG-4, but is not limited thereto. Generally, in order to reduce the amount of data generated when recording videos, compression schemes are used wherein individual frames, i.e. individual pictures or images of a sequence of frames forming a video stream, are encoded based on one or more preceding frames and/or with reference to one or more preceding and one or more following frames, such that only the differences to preceding and/or following frames need to be encoded.

Additionally, in order to provide a reference or “starting point” for such encoding, some frames are encoded only based on the respective frame itself, wherein the encoding in this case may use any suitable compression mechanism, for example compression mechanisms corresponding to or like JPEG compression, to compress such frames. These frames which are encoded only based on themselves will be referred to as I-frames (intracoded frame). Such I-frames correspond to a still picture and for example may serve as anchor points for random access to the video, i.e. when a viewer desires to jump to a specific portion of the recorded video.

Frames which are encoded based on one or more preceding frames are in the following referred to as P-frames (predictive coded frames), and frames which are encoded based on preceding and following frames are referred to as B-frames (bidirectional coded frames). A group of frames starting with an I-frame and ending with the frame preceding the next I-frame is sometimes referred to as GOP (group of pictures).

The encoded video stream b may then be stored on any desired storage medium (not shown) like a memory card, a DVD (digital versatile disc) or a hard disc or may be transferred via a network like a wireless network or a wire-based network.

In order to activate the zooming of zoom lens 11, the embodiment of FIG. 1 further comprises a zoom control 14. Zoom control 14 may for example comprise one or more buttons or other input elements which allow a user to activate and direct the zoom operation and corresponding circuitry to translate the input of the user into a first control signal c1 controlling zoom lens 11 accordingly. Furthermore, in the embodiment of FIG. 1 zoom control 14 generates a second control signal c2 which is fed to encoder 13. Second control signal c2 may in an embodiment be the same signal as control signal c1, and in another embodiment may be a simple binary signal having two states, one state indicating that a zoom operation is currently being performed and the other state indicating that no zoom operation is currently being performed. Irrespective of the type of control signal c2, based on control signal c2 encoder 13 recognizes when a zoom operation is taking place. In an embodiment, when control signal c2 indicates that a zoom operation is taking place, encoder 13 increases the number of I-frames per time unit used in encoding. For example, as long as no zoom operation is taking place, 2 I-frames per second or 4 I-frames per second may be used, and during the time a zoom operation takes place, this number may for example be doubled, for example to 4 or 8 I-frames per second, respectively. However, the invention is not limited to these numerical examples, and other values and other ratios between I-frames per second during zoom operation and I-frames per second during periods without zoom operation may be used. This will be further explained with reference to FIG. 2.

FIG. 2 schematically shows a series of frames generated in accordance with a method according to an embodiment of the present invention, for example a method implemented in encoder 13 of the embodiment of FIG. 1. In FIG. 2, the above-mentioned I-frames are labeled with reference numeral 20, whereas other frames like the aforementioned P-frames and B-frames are generally labeled 21. It should be noted that each block denoted 21 may comprise a plurality of frames like P-frames, B-frames or also other types of frames like so-called D-frames which are used for fast forwarding in some encoding schemes. A time during which a zoom operation takes place is indicated by an arrow 22. As can be seen from the example of FIG. 2, during the zoom operation the rate of I-frames 20 per time unit is approximately doubled compared to the time when no zoom operation takes place. In other words, during times where no zoom operation takes place, a first rate of I-frames is used, and during the time the zoom operation takes place as indicated by arrow 22 a second rate of I-frames higher than the first rate is used in the embodiment of FIG. 2.

It should be noted that neither the first rate nor the second rate is necessarily constant, as both rates may also be varied based on other criteria, for example the images to be encoded. Furthermore, the second rate, i.e. the rate of I-frames per time unit used during zoom operation, may be varied depending on the speed the zoom operation is performed, i.e. the speed the angle defining the field of view changes, in an embodiment of the present invention.

Furthermore, it should be noted that while in the embodiment discussed with reference to FIG. 2 the rate of I-frames is increased only during the zoom operation itself, in another embodiment the increased rate may be kept for a predetermined time after the termination of the zoom operation or may start immediately when a user input is registered indicating a zoom operation, whereas the zoom operation itself may start likely delayed to such a registering in an embodiment. On the other hand, there may be a time lag so that the increase of the rate of I-frames takes place after the commencing of the zoom operation. Furthermore, while in the above-discussed embodiments a zoom operation using an optical zoom, i.e. a zoom lens where optical elements move in order to create a zoom effect, have been discussed, in other embodiments a digital zoom where the zooming is performed operating on the output of a corresponding sensor may also be used. Therefore, as can be seen, many variations and modifications are possible without departing from the scope of the present invention, which is intended to be limited only by the appended claims and equivalents thereof.

What is claimed is:

1. A video recording device, comprising: an image sensor,
a zoom arrangement operable to change an angle defining a field of view seen by said sensor, and
an encoder configured to output a stream of video frames based on an output of said sensor, wherein said video frames comprise first frames, wherein each first frame is encoded based only upon itself, and second frames, wherein each second frame is encoded based on at least one frame preceding the respective second frame, and wherein said encoder is further configured to increase a rate of said first frames per time unit during at least part of a time period in which said zoom arrangement is operated to change said angle defining the field of view.

2. The video recording device of claim 1,
wherein said rate of said first frames per time unit is increased during the complete time period in which the zoom arrangement is operated to change said angle defining the field of view.

3. The video recording device of claim 1,
wherein said zoom arrangement comprises a plurality of optical elements, wherein at least one of said optical elements is movable to change said angle defining the field of view.

4. The video recording device of claim 1,
wherein said encoder is configured to generate said stream of video frames based on an MPEG-standard.

5. The video recording device of claim 1,
wherein said video recording device is selected from the group comprising a mobile phone, a laptop computer, a digital camera, a video camera and a portable music player.

6. The video recording device of claim 1,
wherein said image sensor may comprise at least one sensor chosen from the group comprising a CCD sensor and a CMOS sensor.

7. The video recording device of claim 1,
wherein each of said first frames is an I-frame, and each of said second frames is either a P-frame or a B-frame.

8. The video recording device of claim 8, further comprising a control unit, wherein said control unit is configured to receive a user input indicative of a desire of a user to change said angle defining the field of view and to output a first control signal controlling said zoom arrangement to change said angle defining the field of view and a second control signal controlling said encoder to increase said rate of said first frames per time unit.

9. A method, comprising:
capturing a series of images,
encoding said stream of images into a stream of video frames,
wherein said video frames comprise first frames, wherein each first frame is encoded only based upon itself, and second frames, wherein each second frame is encoded based on at least one frame preceding the respective second frame,
changing an angle defining a field of view seen by said image sensor, and
increasing a rate of said first frames per time unit in said stream of video frames during at least part of the time the angle defining the field of view is changed.

10. The method of claim 9,
wherein said changing of said angle defining said field of view comprises operating an optical zoom arrangement.

11. The method of claim 9,
wherein said encoding is performed based on an MPEG-standard.

12. The method of claim 9,
wherein each of said first frames is an I-frame, and each of said second frames is either a P-frame or a B-frame.
